(19) United States
(12) Patent Application Publication
(10) Pub. No.: US 2026/0002751 A1
(43) Pub. Date: Jan. 1, 2026

(54) FIREARM SUPPRESSOR AND METHOD OF MANUFACTURING

(71) Applicant: B&T USA, LLC, Tampa, FL (US)

(72) Inventor: Sean Sullivan, Tampa, FL (US)

(21) Appl. No.: 19/250,862

(22) Filed: Jun. 26, 2025

Related U.S. Application Data
(60) Provisional application No. 63/664,658, filed on Jun. 26, 2024.

(51) Int. Cl. F41A 21/30; B33Y 80/00

(52) U.S. Cl. CPC F41A 21/30; B33Y 80/00

(57) ABSTRACT

A firearm suppressor is disclosed. The firearm suppressor including an outer housing having first and second opposing ends; a first baffle disposed in and connected to an inner surface of a wall of the outer housing proximate the first end, the first baffle including a first bore extending therethrough; and at least one baffle disposed in and connected to the inner surface of the wall of the outer housing between the first and second opposing ends, wherein the at least one baffle includes a skirt and a stepped protrusion extending axially from the skirt, the stepped protrusion having an outer wall surface defined by a plurality of rounded arms, an upper portion, and a lower portion, the upper portion extending axially from the skirt further than the lower portion.

### TECHNICAL FIELD

The present invention relates to a particular shape of baffle used in a firearm suppressor and the method of manufacturing the suppressor. In its preferred form, the firearm suppressor is manufactured, using additive manufacturing processes, with one or more baffles that have a unique, waveform shape, similar to a 6-pointed star or a flapjack octopus (with only six tentacles). More generally, the instant invention relates to an additive manufactured, universal firearm suppressor that may be mounted to various firearms, and more particularly to a suppressor having uniquely shaped baffles for dissipating the gasses that accompany a projectile when discharged from the firearm.

### BACKGROUND

A silencer or suppressor works by containing and slowly releasing the gas and pressure of a projectile or bullet fired from a firearm. Silencers and/or suppressors are necessary to dampen the sound and reduce the flash created when the firearm is fired. Suppressors are available in many different sizes and shapes. Typically, there are four classes of suppressors: reactive, dissipative, absorptive, and dispersive/diffusive. A reactive silencer uses geometry rather than sound absorbing materials to reduce noise from a firearm. An absorptive silencer, on the other hand, uses sound absorbing materials. With dissipative suppressors, flow resistance is utilized to reduce the velocity of the gasses. Finally, dispersive/diffusive suppressors diffuse high-velocity turbulent gas to a lower velocity, less blustery flow, which allows for less sound to be generated as the firearm is fired. In various suppressors, more than one type of suppression is used. Some silencers have even used spark arresting, water separation, heat recovery, or filtering to achieve the desired results.

Silencers may be attached to the muzzle of a firearm prior to firing the firearm. Ultimately, each type of silencer discussed above dampens sound by trapping or slowing the expanding gasses produced when the bullet or projectile is fired. However, contrary to popular belief, a silencer does not entirely suppress the sound of the firearm. Rather, it merely reduces the decibels ordinarily produced by a particular firearm.

Traditional suppressors known in the art use a variety of baffles that are separately formed and then filed into a suppressor tube and retained using some sort of end cap. Traditional style suppressor baffles include cone-shaped, M-shaped, K-shaped, and Omega-shaped baffles (Ω). However, the suppressors with these baffles fail easily, making it costly to replace, and do not dampen the sound as much as a user may want. In fact, gun and suppressor manufacturers continue to alter and experiment with the shape of the suppressor and its internal components to improve hearing protection, reduce noise pollution, and create suppressors that do not fail during high intensity use situations resulting in additional costs for the consumer.

Accordingly, there is a need for a firearm suppressor that has the ability to better reduce back pressure when compared to suppressors having traditional style baffles, increase the surface area for gas disruption to further dampen the sound emitted from the firearm, manufacture a suppressor that is sized and shaped so that it can adequately handle the gas disruption so that the suppressor will not fail after only limited use, and easily mass produce the suppressor using additive manufacturing processes; thereby driving down the cost for the consumer.

### BRIEF SUMMARY

Shortcomings of the prior art are overcome and additional advantages are provided by a firearm suppressor manufactured using an additive manufacturing process to create uniquely shaped baffles for dissipating gases.

Additionally disclosed herein, a firearm suppressor includes an outer housing having first and second opposing ends; a first baffle disposed in and connected to an inner surface of a wall of the outer housing proximate the first end, the first baffle including a first bore extending therethrough; and at least one baffle disposed in and connected to the inner surface of the wall of the outer housing between the first and second opposing ends, wherein the at least one baffle includes a skirt and a stepped protrusion extending axially from the skirt, the stepped protrusion having an outer wall surface defined by a plurality of rounded arms, an upper portion, and a lower portion, the upper portion extending axially from the skirt further than the lower portion.

Also disclosed herein, the upper portion includes a first end wall and the lower portion includes a second end wall.

Also disclosed herein, the stepped protrusion further includes a bore extending through a portion of the first end wall and a portion of the second end wall.

Also disclosed herein, the suppressor further includes at least one strut disposed in the first end and connected to the inner surface of the wall of the outer housing and the first baffle.

Also disclosed herein, each of the first baffle and at least one baffle are integrally formed with the inner surface of the wall of the outer housing.

Also disclosed herein, the first baffle includes a scallop to direct and control a flow of gases flowing through the firearm suppressor.

Also disclosed herein, the suppressor further includes a tube in and connected to the inner surface of the wall of the outer housing proximate the second end, the tube including a bore extending therethrough.

Also disclosed herein, the tube includes at least one annular groove formed in an inner wall surface of the tube

Also disclosed herein, a firearm suppressor includes an outer housing having first and second opposing ends; a first baffle disposed in and connected to an inner surface of a wall of the outer housing proximate the first end, the first baffle including a first bore extending therethrough; a tube disposed in and connected to the inner surface of the wall of the outer housing proximate the second end, the tube including a second bore extending therethrough and a plurality of annular grooves formed in an inner wall surface of the tube; and a plurality of intermediate baffles disposed in and connected to the inner surface of the wall of the outer housing between the first baffle and the tube, wherein each of the plurality of baffles include a third bore extending therethrough and a plurality of rounded arms surrounding the third bore.

Also disclosed herein, each of the first baffle, tube, and plurality of intermediate baffles are integrally formed with the inner surface of the outer wall of the outer housing.

Also disclosed herein, the plurality of intermediate baffles are hexagram baffles disposed in series in the outer housing.

Also disclosed herein, each of the plurality of intermediate baffles include: a top surface facing the first end, wherein the plurality of rounded arms project outwardly from the top surface towards the first end; and a bottom surface facing the second end, wherein the bottom surface includes a plurality of rounded valleys.

Also disclosed herein, the suppressor further includes at least one strut disposed in the first end and connected to the inner surface of the wall of the outer housing and the first baffle.

Also disclosed herein, the first baffle includes a scallop to direct and control a flow of gases flowing through the firearm suppressor.

Also disclosed herein, the suppressor further includes a plurality of flash vents disposed around the second bore of the tube.

Also disclosed herein, each of the plurality of intermediate baffles include a skirt and a protrusion extending axially from the skirt.

Also disclosed herein, the protrusion includes an upper portion and a lower portion, the upper portion extending axially from the skirt further than the lower portion.

Also disclosed herein, each of the plurality of intermediate baffles includes:
a skirt having a wall with a top surface and a bottom surface; and a protrusion extending axially from an end of the skirt and including an outer wall surface and an inner wall surface, the outer wall surface being defined by the plurality of rounded arms surrounding the third bore, wherein each of the plurality of arms is separated by a valley; and wherein the protrusion further includes an upper portion with an end wall and a lower portion with an end wall, the upper portion extending axially further from the skirt than the lower portion, and wherein the third bore is defined by the end walls of the upper and lower portions.

Also disclosed herein, a method of manufacturing the firearm suppressor of claim 1 includes using an additive manufacturing process to build the firearm suppressor in a layer-by-layer fashion.

### BRIEF DESCRIPTION OF THE DRAWINGS

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1 is a perspective view of a front or first end of a firearm suppressor, in accordance with an embodiment of the present invention.

FIG. 2 is perspective view of a rear or second end of the firearm suppressor of FIG. 1, as viewed from the second end.

FIG. 3 is a first side view of the firearm suppressor of FIG. 1.

FIG. 4 is a second side view of the firearm suppressor of FIG. 1.

FIG. 5 is a front view of the second end of the firearm suppressor of FIG. 1.

FIG. 6 is a front view of the first end of the firearm suppressor of FIG. 1.

FIG. 7 is a partial perspective view of the second end shown in FIG. 5 in accordance with an example embodiment of the firearm suppressor of FIG. 1.

FIG. 8 is a partial perspective view of the first end shown in FIG. 6 in accordance with an example embodiment of the firearm suppressor of FIG. 1.

FIG. 9 is a sectional view of the firearm suppressor of FIG. 1.

FIG. 10 is a sectional, perspective view of the firearm suppressor of FIG. 1.

FIG. 11 is a sectional, perspective view of the firearm suppressor of FIG. 1.

FIG. 12 is a partial perspective view from the second end of the firearm suppressor of FIG. 1 with an exemplary baffle shown.

FIG. 13 is a partial perspective view from the first end of the firearm suppressor of FIG. 1 with an exemplary baffle shown.

FIG. 14 is a partial sectional view of the second end of the firearm suppressor of FIG. 1 with an exemplary expansion/compression tube having one or more chambers and a center chamber for venting gas back into the firearm suppressor to mitigate muzzle flash and sound.

FIG. 15 is a partial sectional view of the first end of the firearm suppressor of FIG. 1 with an exemplary cone-shaped baffle having a scallop for venting gas back into the firearm suppressor to mitigate muzzle flash and sound while the cone-shaped baffle allows the firearm suppressor to maintain its integrity so that it may last longer.

FIG. 16 is a perspective view of first surface of a baffle that may be coupled to the firearm suppressor of FIG. 1, the baffle having a unique shape.

FIG. 17 is a perspective view of an opposing surface of the baffle of FIG. 16 for coupling to the firearm suppressor of FIG. 1.

FIG. 18 is a front view of the first surface of the baffle, as shown in FIG. 16.

FIG. 19 is a rear view of the opposing surface of the baffle, as shown in FIGS. 16 17, and 18.

FIG. 20 is a first side view of the baffle shown in FIG. 16 illustrating the higher step portion of the baffle.

FIG. 21 is a second side view of the baffle shown in FIG. 16 illustrating the lower step portion of the baffle as compared to the higher step portion of FIG. 20.

FIG. 22 is a third side view of the baffle shown in FIG. 16 illustrating the lower step portion of the baffle as compared to the higher step portion of FIG. 20.

FIG. 23, similarly, is a fourth side view of the baffle shown in FIG. 16 illustrating the lower step portion of the baffle as compared to the higher step portion of FIG. 20.

FIG. 24 is a partial sectional view of the second end of the firearm suppressor of FIG. 1 with greater details illustrating one or more chambers for venting gas, as shown in FIG. 14.

FIG. 25 is a front view of the baffle illustrating various angles, measurements, and thread patterns for the one or more baffles for use within the firearm suppressor of FIG. 1.

FIG. 26 is an example embodiment of a firearm suppressor of FIG. 1 coupled to a firearm.

FIG. 27 illustrates a partial sectional view of the firearm suppressor of FIG. 1 with the one or more baffles arranged in a series within a relatively longer tube.

FIG. 28 illustrates a partial sectional view of the firearm suppressor of FIG. 1 with the one or more baffles arranged in a series within a relatively shorter tube.

FIG. 29 illustrates a partial sectional view of the firearm suppressor of FIG. 1 with the uniquely shaped baffles and no cone-shaped baffle.

FIG. 30, similarly, illustrates a partial sectional view of the firearm suppressor of FIG. 1 with a single uniquely shaped baffle.

FIG. 31 illustrates a partial sectional view of the second end of the firearm suppressor of FIG. 1.

FIG. 32 illustrates a first surface of an alternate embodiment of a uniquely shaped baffle that may be incorporated into the firearm suppressor of FIG. 1.

FIG. 33 illustrates an opposing surface of the alternate embodiment of a uniquely shaped baffle as shown in FIG. 32 that may be incorporated into the firearm suppressor of FIG. 1.

FIG. 34 is a front view of the first surface of the alternate embodiment baffle, as shown in FIG. 32.

FIG. 35 is a rear view of the opposing surface of the alternate embodiment baffle, as shown in FIG. 33.

FIG. 36 is a side view of the alternate embodiment baffle as shown in FIGS. 32-35 with the outlet portion shown at the top of the baffle.

FIG. 37 is a side view of the alternate embodiment baffle as shown in FIGS. 32-36 with the inlet portion shown at the top of the baffle.

FIG. 38 is a side view of the alternate embodiment baffle as shown in FIGS. 32-37 with the outlet portion shown at the right of the baffle.

FIG. 39 is a side view of the alternate embodiment baffle as shown in FIGS. 32-38 with the inlet portion shown at the right of the baffle.

FIG. 40 is an exemplary design of the firearm suppressor of FIG. 1.

FIG. 41 illustrates sectional views of suppressors with different baffle designs.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

Unless defined otherwise, technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a,” “an,” and “the” refer to “one or more” when used in the subject specification, including the claims. Unless indicated to the contrary, the numerical parameters set forth in the instant specification and attached claims are approximations that can vary depending upon the desired properties sought to be obtained within the scope of these descriptions. As used herein, the term “about,” when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are within the scope of these descriptions.

Referring to the present invention, various improvements in the art have been made by the current concept. Thus, the new concept reduces noise pollution, protects a user's ears, improves accuracy, provides a tactical advantage, and in some cases, aids in legal compliance where suppressors are mandated or encouraged by law, especially in densely populated areas or for specific types of hunting. Overall, the use of the suppressor is primarily to make shooting safer, more comfortable, and less disruptive to both the shooter and their surroundings.

For example, the shape of the new baffles when compared to traditional baffles (i.e., cone, M, K, and Omega) greatly reduces the back pressure of gas from the baffles. In addition, the baffle shape of the current concept creates an increased surface area for gas disruption, further dampening the sound emitted from the firearm. Similarly, the various angles of the baffles increase the surface area for disrupting the gasses at varying angles, also thereby increasing the dampening effects on the firearm sound. This protects a user's ears from the high decibel sounds produced by the firearm, especially when fired in confined spaces or fired repeatedly over time. This makes the use of a firearm safer for the proper user. Thus, overall, the baffle shape greatly increases sound reduction of any firearm it is mounted on or coupled to.

Further, by using additive manufacturing processes, to manufacture the suppressor as a single unit, mass production is easily accomplished driving down consumer cost, as well as creating a suppressor that is not fallible when compared to prior suppressors that are formed separately and assembled together either by the manufacturer or the user when cleaning the suppressor.

Additive manufacturing is a process in which material is built up layer-by-layer to form a component. Unlike casting processes, additive manufacturing is limited by the position resolution of the machine and not limited by requirements for providing draft angles, avoiding overhangs, etc. Additive manufacturing is also referred to by terms such as “layered manufacturing,” “reverse machining,” and “rapid manufacturing processes” and includes manufacturing processes, but are not limited to, Direct Metal Laser Melting” (DMLM) and/or Direct Metal Laser Sintering (DMLS), Laser Net Shape Manufacturing (LNSM), electron beam sintering, Selective Laser Sintering (SLS), 3D printing, Electron Beam Melting (EBM), Laser Engineered Net Shaping (LENS) and Direct Metal Deposition (DMD). Such terms are treated as synonyms for purposes of the present invention.

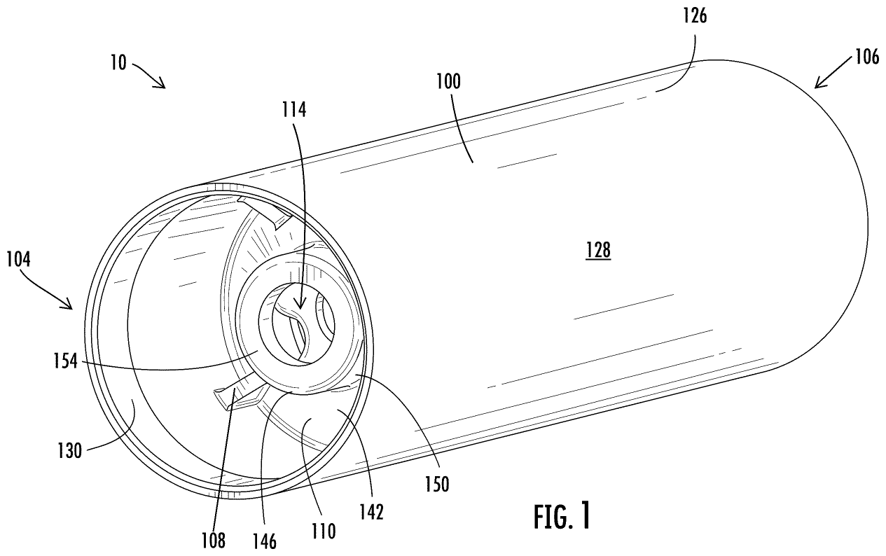

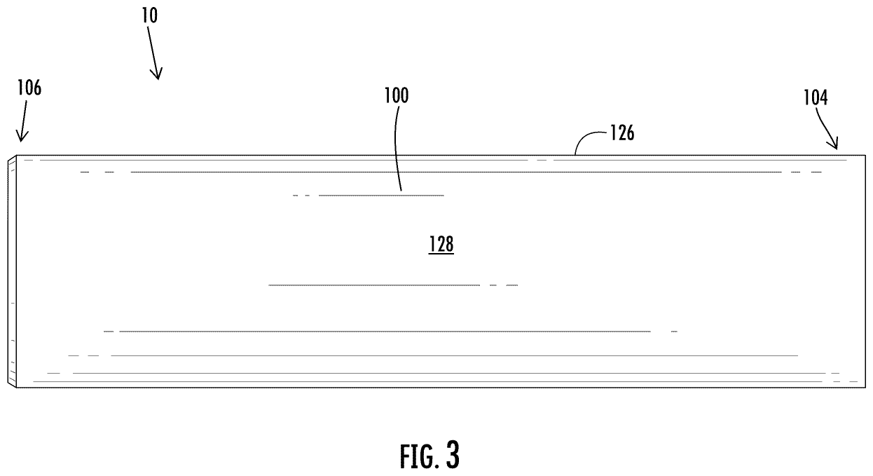

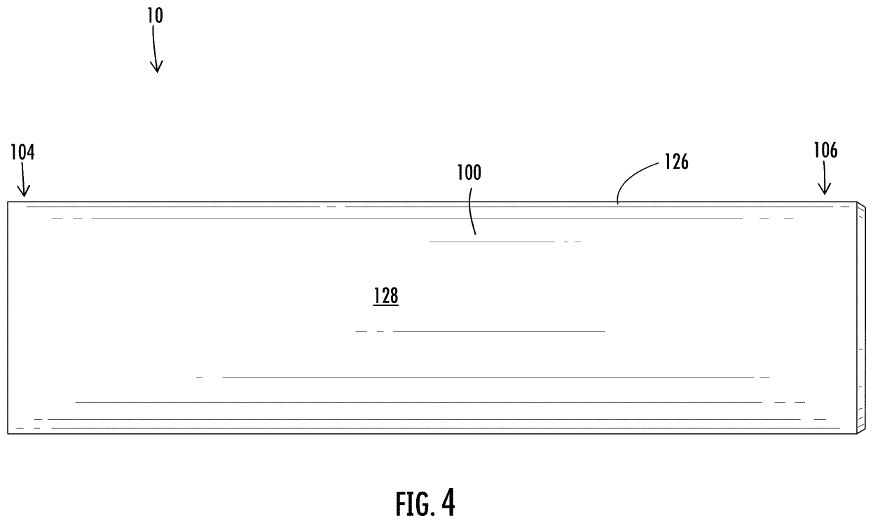

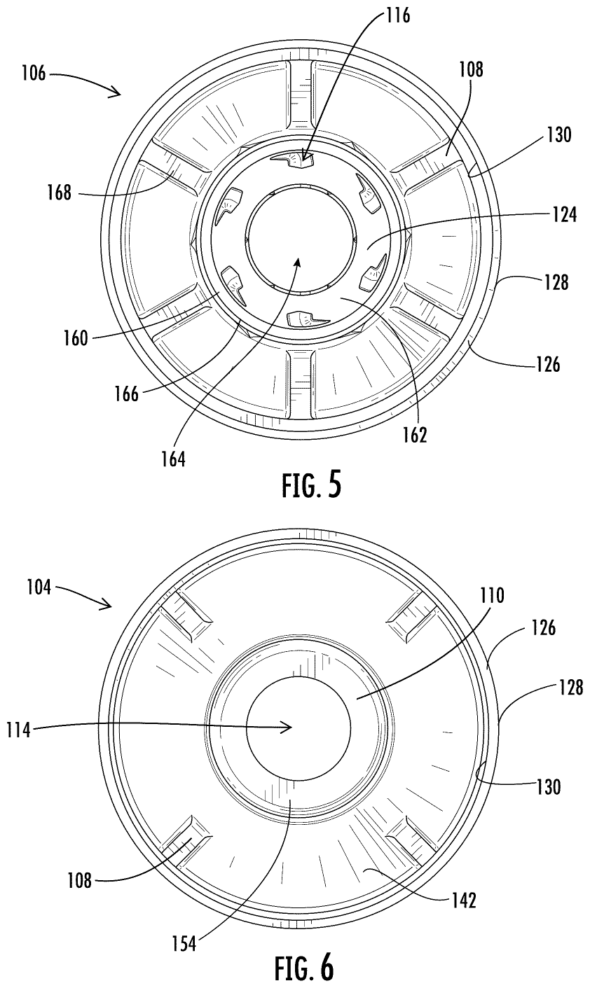

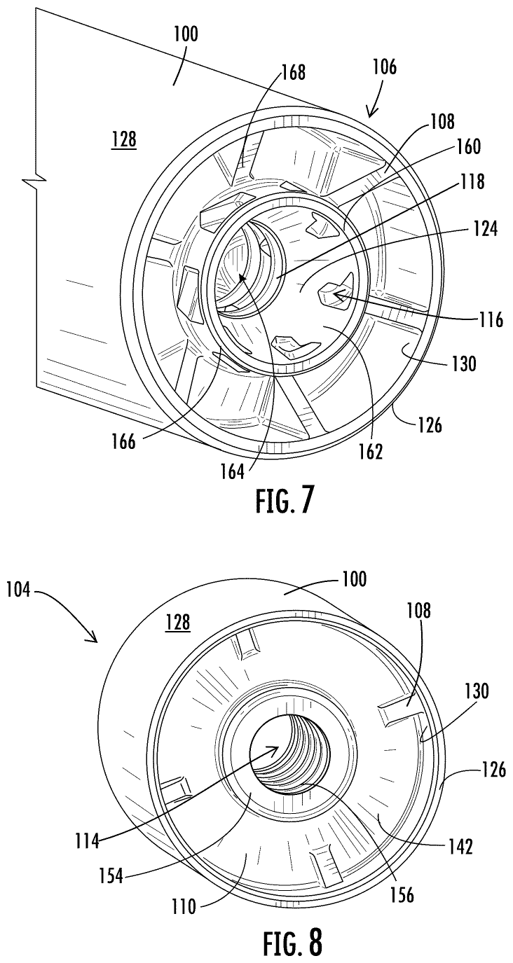

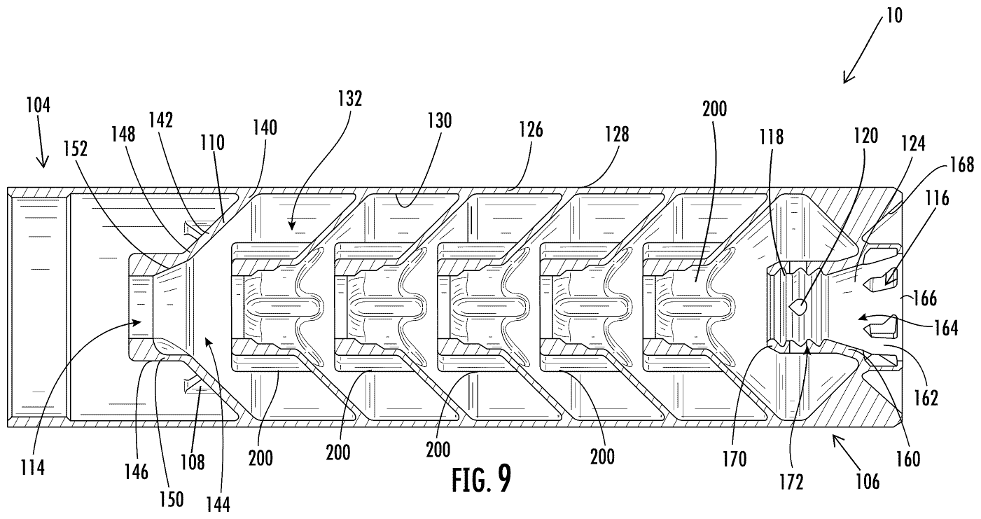

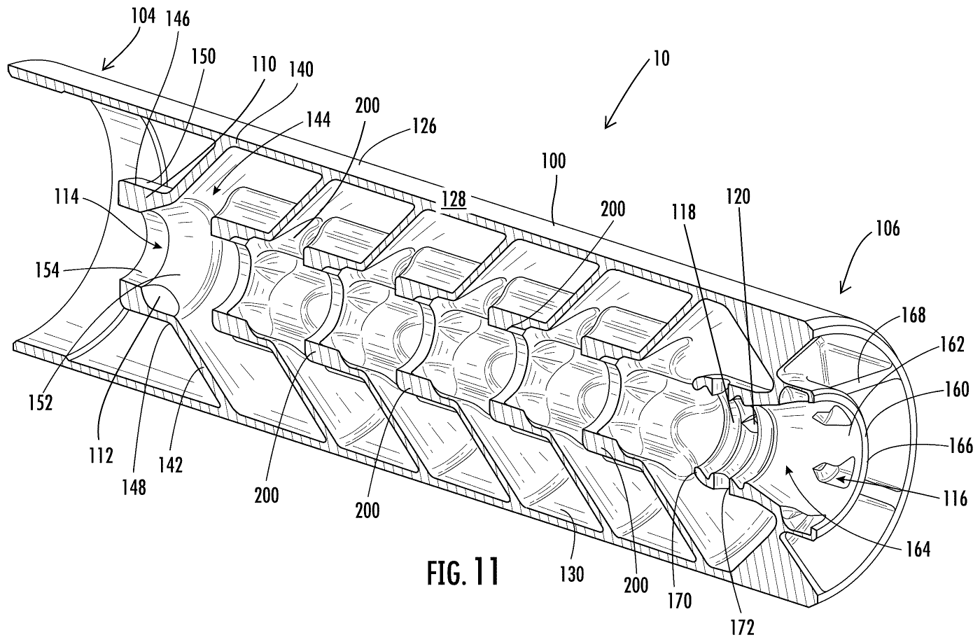

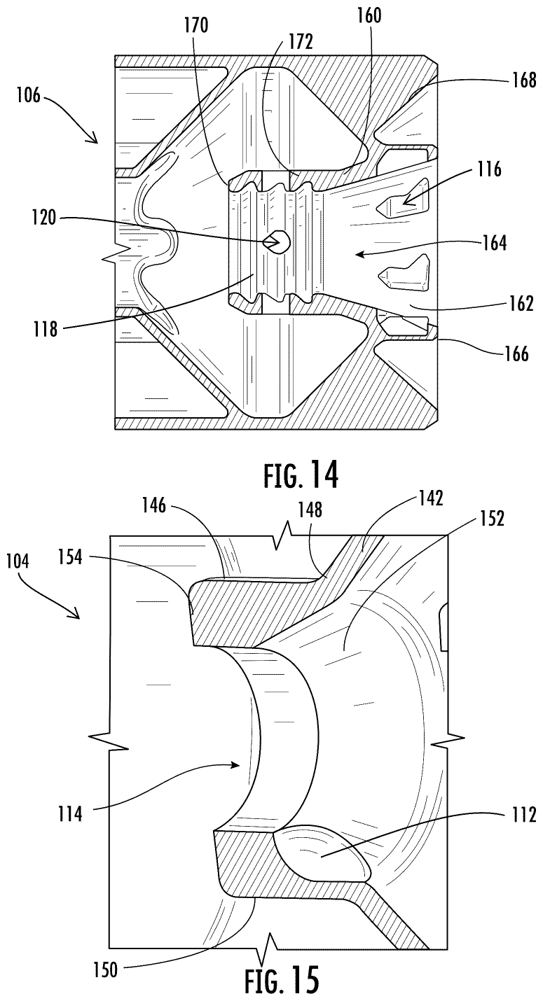

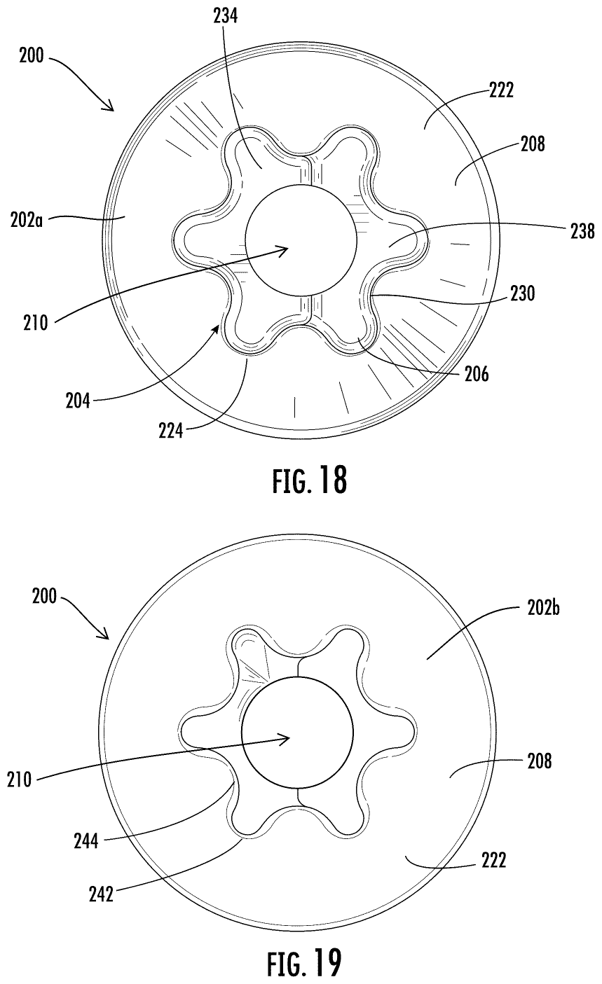

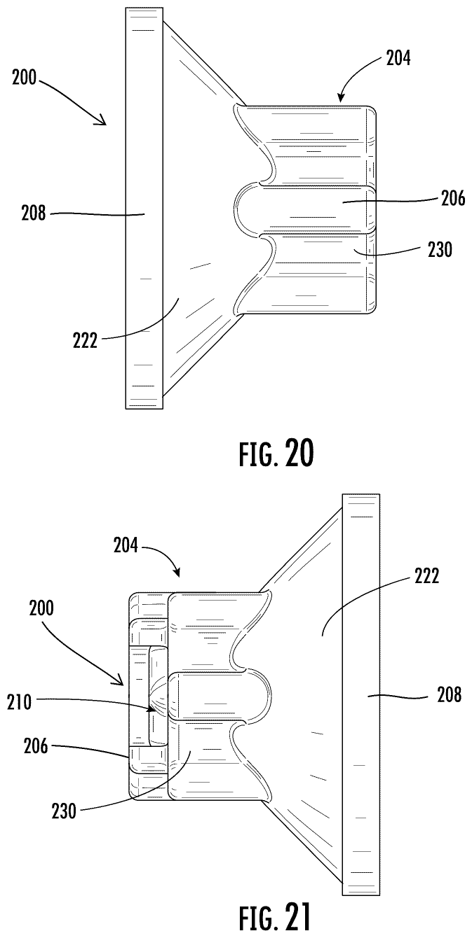

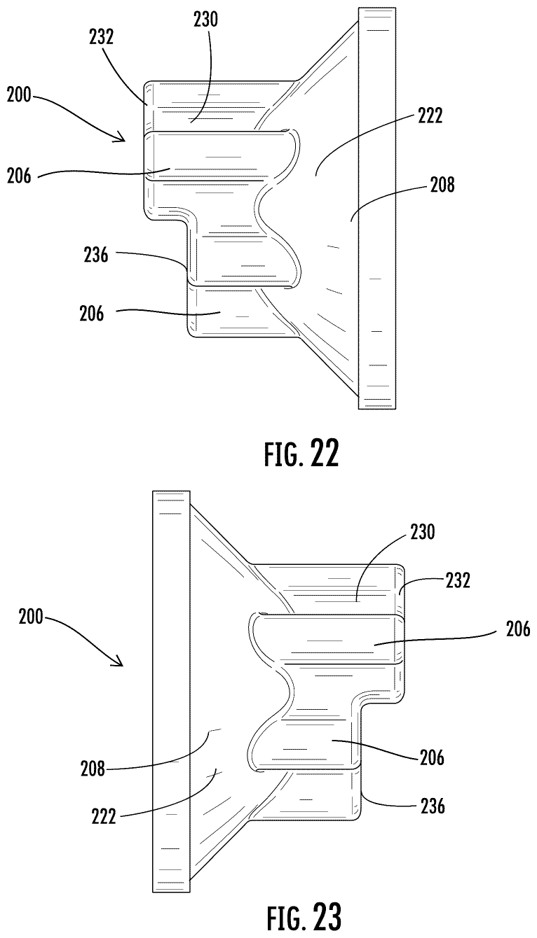

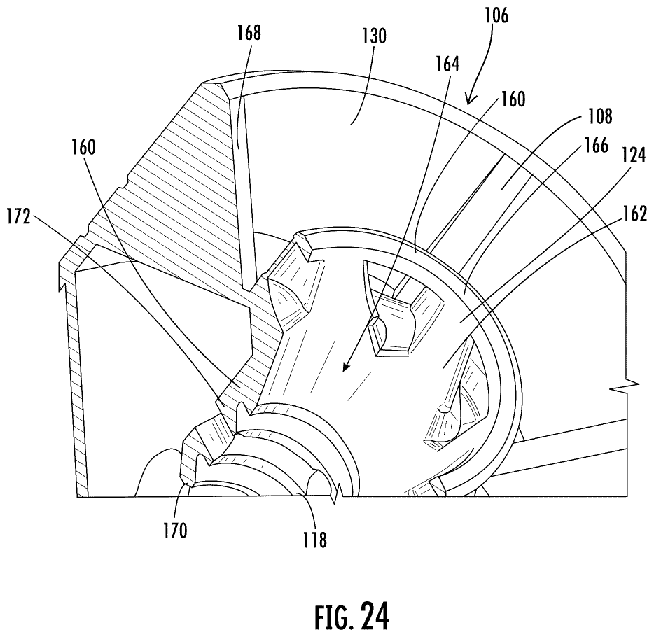

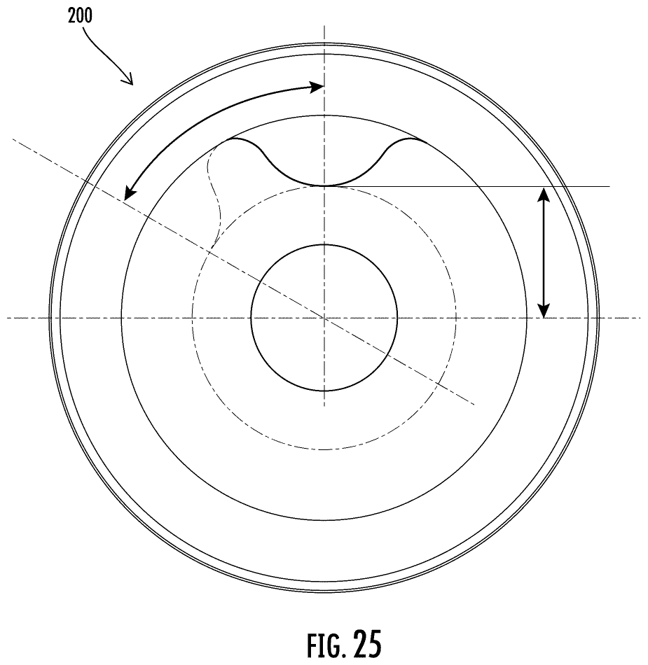

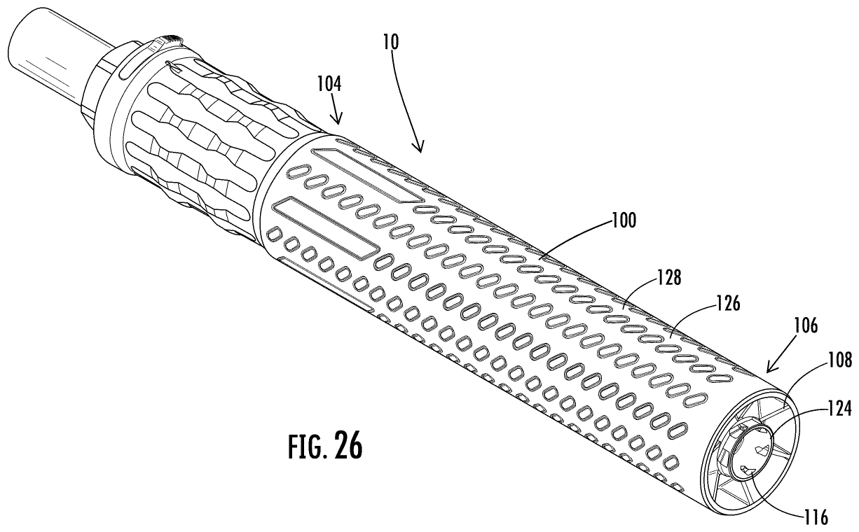

Referring now to FIGS. 1-26, in general, a firearm suppressor 10 includes a housing 100. As shown, the housing 100 is a cylindrical housing and or tube; however, it should be appreciated that other suitable shapes may be used. The housing 100 includes a wall 126 having an outer surface 128 and an inner surface 130 defining a chamber 132 therein. The housing 100 having an inlet or first end 104 and an outlet or second end 106. In some embodiments, a blast baffle 110 is located proximate the first end 104 in the chamber 132 of the housing 100 and a rapid expansion/compression tube 124 is located proximate the second end 106 in the chamber 132 of the housing 100. As illustrated, the blast baffle 110 is a conical baffle, creating a full circle at its aperture proximate the first end 104 of the firearm suppressor 10. It should be appreciated that other suitable baffles may be used.

In various embodiments, the first end 104 and second end 106 include one or more struts 108 or other additional structural pieces to increase the rigidity of the suppressor 10 and strengthen it without adding too much additional weight to the suppressor because the firearm suppressor can be made with less material and thinner walls than any other design allows for. The struts 108 or structural supports increase support to areas that critically fail during high intensity use situations. As illustrated, at the first end 104, the struts 108 extend between the inner wall 130 and the blast baffle 110 and, at the second end 106, between the inner wall 130 and the tube 124 to increase rigidity. One or more baffles 200 are disposed in the chamber 132 of the housing 100 between the blast baffle 110 and the tube 124. As shown, five baffles 200 are disposed in the chamber 132 between the blast baffle 110 and tube 124. It should be appreciated that any suitable number of baffles may disposed between the blast baffle 110 and tube 124.

Various aspects and views of the first end 104 of the firearm suppressor 10 can be seen in FIGS. 1, 6, 8, 9-11, and 15. As shown, the blast baffle 110 has a truncated conical shape with a base 140, a sloped wall 142 defining an open space 144, and a projection 146 extending axially from an end 148 of the sloped wall 142. The projection 146 having an outer wall 150, an inner wall 152, and an end wall 154 having an aperture 114 extending therethrough. The aperture 114 allows a bullet fired from the firearm to pass through the center of the firearm suppressor 10. In various embodiments, the aperture 114 may be threaded 156 or have any other suitable textured or smooth surface that allows a bullet or other projectile, along with the gas that has built up pressure behind the bullet, to travel down and out of the firearm suppressor as it is forced out by the gas build up.

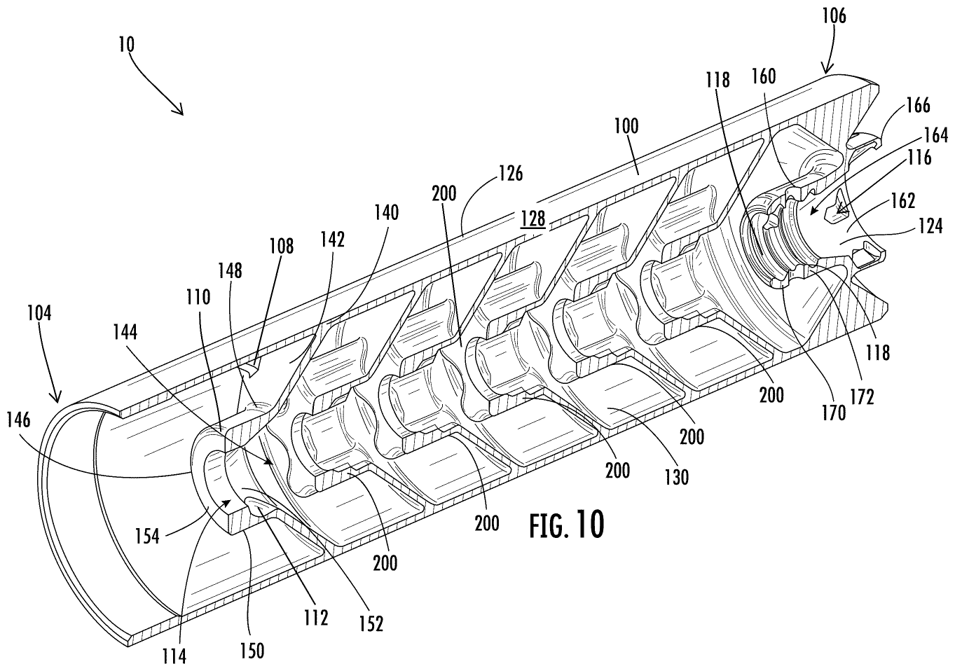

As illustrated in FIGS. 10 and 15, a unique feature 112 is disposed on the inner wall 152 of the projection 146 of the baffle 110. In some embodiments, the unique feature, also known as a scallop 112 (e.g., a notch or cutout on the edge of the baffle that helps direct and control the flow of gases as they pass through the suppressor) creates a jet or circulation of gas which causes significant disruption in gas flow, ultimately improving the firearm suppressor's performance. Additionally, by using a more standard cone style baffle 110, the front ring allows for significant wear improvement as it is the object to encounter the gas and projectile from the firearm. This allows for the suppressor to have a significantly longer lifespan than other suppressors on the market.

Although not shown, any suitable mounting system (i.e., direct thread, quick detach, fixed mount, passive locking, active locking, combination of passive and active locking, integral suppressor, and taper mount) may be used to couple the first end 104 of the firearm suppressor 10 to a firearm. In some embodiments, the firearm suppressor 10 is coupled using a quick attachment system.

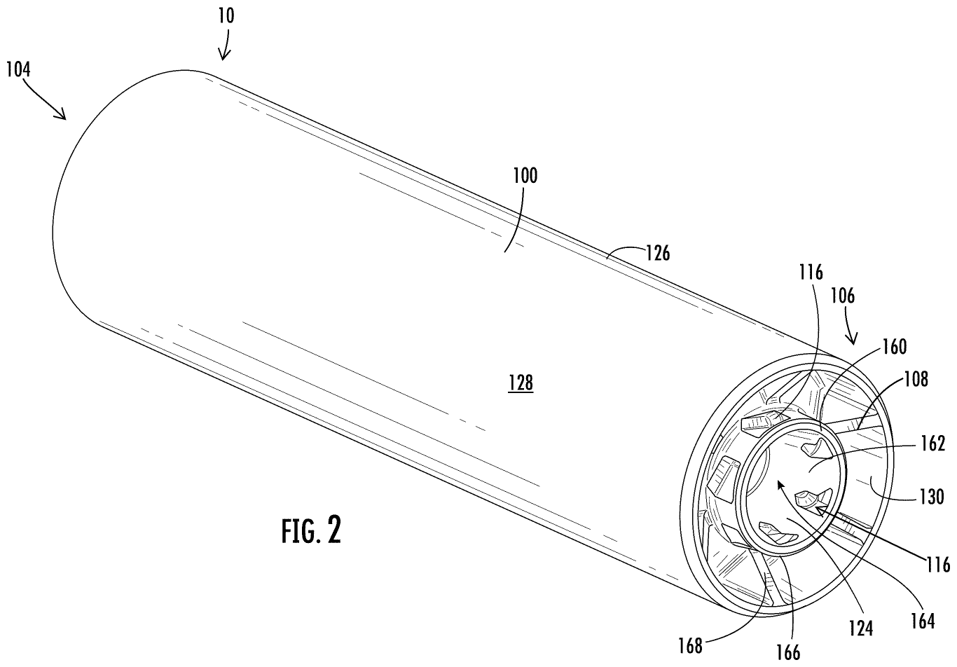

Referring to FIGS. 2, 5, 7, 9-11, and 14, tube 124 is disposed proximate the second end 106 of the firearm suppressor 10 and includes a wall 160 with an inner wall surface 162 defining a bore 164 therethrough. One or more flash vents 116 are disposed around a periphery of an exit end 166 of the tube 124. The flash vents 116 extend through the wall 160 in a circular series, which deflects gas straight, and then at a 90° angle, thereby further increasing travel and dissipation time of the gasses—which ultimately minimizes the sound that is audible from the firearm. The flash vents 116 further help push gas and visible light into an opposing 45° angle surface 168 of the struts 108 and inner surface 130 of the wall 126 at the second end 106, which then redirects the gas and light forward for a final time. Thus, these vents minimize the perceived flash and sound coming out of the firearm and end of the firearm suppressor 106. In other words, the vents or ports change the direction of the gas at a right angle, and then direct it into the 45 degree strut and the outer wall. This shields the flash and noise from initial detection from someone observing from the side of the suppressor and directs it forwards.

Proximate an entrance end 170 of the tube 124, the tube includes a series of three (3) annular grooves or micro chambers 118. The micro chambers 118 are formed in inner wall surface 162. Any suitable number of micro chambers 118 may be used. The center one of the micro chambers 118 includes a vent 120 to vent back into the chamber 132 of the firearm suppressor 10. This configuration further mitigates the flash and adds one final circular gas disruption event as the hot gas prepares to exit the suppressor. As illustrated, the tube 124 expands outwardly from a middle portion 172 of the tube 124 after the micro chambers 118 to the exit end 166 of the tube 124.

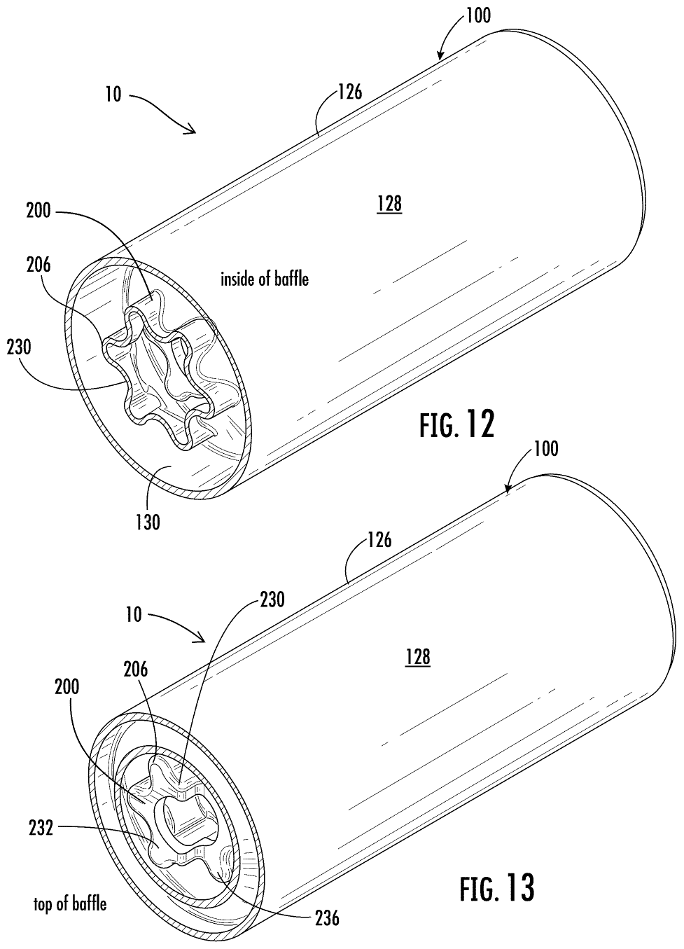

Referring now to FIGS. 12-13, 16-23, and 25, as discussed above, one or more baffles 200 are disposed in the chamber 132 between the blast baffle 110 and the tube 24. As illustrated, the baffles 200 are curved-sided hexagram baffles 200 disposed in series within the chamber 132 of the housing 100. The hexagram baffles 200 may also be considered to vaguely resemble a flapjack octopus, if that octopus only had six (6) arms.

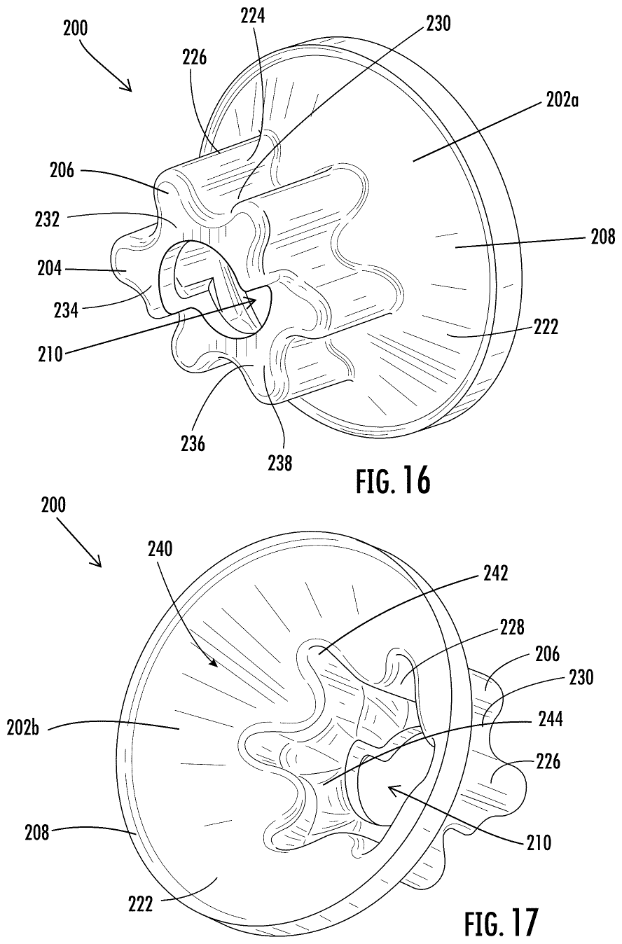

Referring more specifically to FIGS. 16-23, and describing a singular baffle as all of the following baffles are identical, the hexagram baffle 200 includes a body or skirt 208 having a wall 222 with a top surface 202a and a bottom surface 202b and a protrusion 204 extending axially from the skirt 208—the protrusion 204 including a wall 224 with an outer wall surface 226 and an inner wall surface 228. The protrusion 204 is fixedly coupled to the skirt 208, which is generally conical—have a convex surface that faces the first end 104 of the housing 100, and includes a plurality of rounded lobes or arms 206. Each of the arms 206 are separated by a recess or valley 230. As illustrated, the protrusion 204 includes six (6) rounded arms 206; however, other suitable numbers of arms may be used. The protrusion 204 is stepped to create a two-step surface or two step protrusion and includes an upper portion 232 having a first end wall 234 and a lower portion 236 having a second end wall 238; thus, the first end wall 234 is higher than the second end wall 238 or the upper portion 232 extends, axially, further out from the skirt 208 than the lower portion 236. The center bore 210 extends through a portion of the first end wall 234 and a portion of the second end wall 238.

The skirt 208 defines an open area 240 and the protrusion 204 is hollow; thus, the inner wall surface 228 of the protrusion 204 is the reverse of the outer wall surface 226. More particularly, the inner wall surface 228 for the arms 206 form valleys 242 and the inner wall surface 228 for the valleys 230 form arms 244. The hexagram baffle 200 is disposed in the chamber 132 of the housing 100 such that the top surface 202a faces the firearm and first end 104 of the housing 100 and the bottom surface 202b faces the second end 106 of the housing 100. As the arms 206 of the protrusion 204 protrude outwardly toward the first end 104 of the housing 100, they create a wave-like or flower-like design, curving in and out from the center bore 210 of the hexagram baffle 200. Collectively, the aperture 114, center bore 210 of each baffle 200, and bore 164 of tube 124 are aligned and define a central passage or bore for a bullet and gases to pass through and exit the suppressor 10.

Returning to FIG. 16, because the protrusion 204 is split into an upper portion 232 and a lower portion 236, the gas that forces the bullet out of the chamber hits the surfaces of these baffles 200 at varying times so that the gas is not pushed backwards like it would be if it were hitting a circular surface as found in other firearm suppressors. Additionally, because the upper portion 232 has such a large surface area for the gas to hit, each of the arms 206 slow the gas down and increase the performance of the muffling of the sound. Thus, the gas hits the upper portion 232 first and then it goes down the lower portion 236 and down the valleys 230 before it goes down along the top surface 202a of the skirt 208, hitting the cone structure before it is able to pass through the center bore 210, where it will encounter exactly the same style baffle 200 in series with the first, until it ultimately leaves the firearm suppressor 10 from the outlet at the second end 206 at a quieter and slower pace than that which it left the firearm. Because of the slowing of the gasses, the firearm suppressor 10 having the curved-sided hexagram baffles 200 is able to protect the user's ears, reduce noise pollution, improve the accuracy of the projectile, provide a tactile advantage to the user, and, in some cases, help the user comply with the law.

While manufacturing technologies, such as casting may be used, additive manufacturing permits these improvements over the suppressors currently available to be made with greater efficiency and quality. In general, the additive manufacturing process for manufacturing the suppressors 10 includes moving a build platform to an initial high position. A layer increment of metal powder is then deposited on the build platform and leveled. The layer increment affects the speed of the additive manufacturing process and the resolution of the suppressor. As an example, the layer increment may be about 10 to 50 micrometers (0.0003 to 0.002 in.). The leveled powder may be referred to as a “build layer” and the exposed upper surface thereof may be referred to as a “build surface”.

A directed energy source is used to melt a two-dimensional cross-section or layer of the suppressor being built. The directed energy source emits a beam and a beam steering apparatus is used to steer a focal spot of the build beam over the exposed powder surface in an appropriate pattern. A small portion of exposed layer of the powder surrounding the focal spot, referred to herein as a “weld pool” is heated by the build beam to a temperature allowing it to melt, flow, and consolidate. As an example, the weld pool may be on the order of 100 micrometers (0.004 in.) wide. This step may be referred to as fusing the powder.

The build platform is moved vertically downward by the layer increment, and another layer of powder is applied in a similar thickness. The directed energy source again emits a build beam and the beam steering apparatus is used to steer the focal spot of the build beam over the exposed powder surface in an appropriate pattern. The exposed layer of the powder is heated by the build beam to a temperature allowing it to melt, flow, and consolidate both within the top layer and with the lower, previously-solidified layer, again maintaining the crystallographic orientation of the layers below.

This cycle of moving the build platform, applying powder, and then directed energy melting the powder is repeated until the entire suppressor is complete. Machines capable of this type of additive manufacturing process are commercially available from EOS GmbH located in Krailing, Germany.

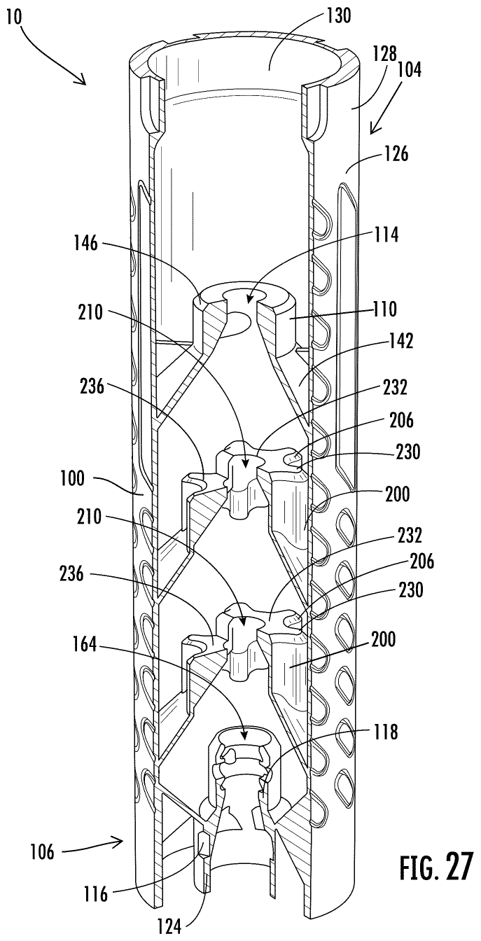

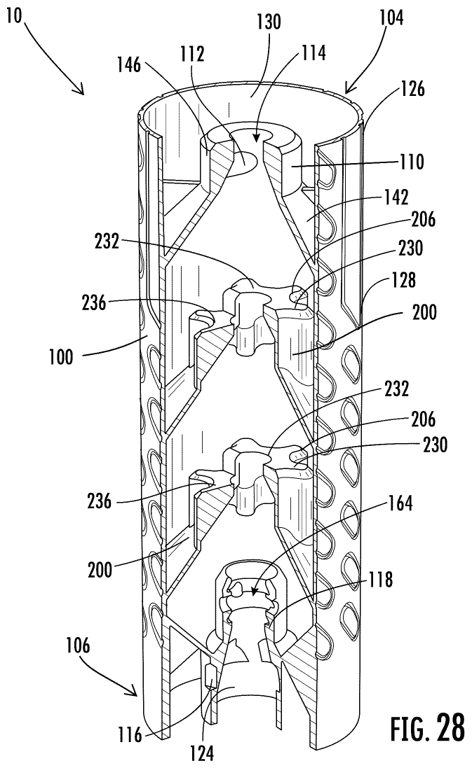

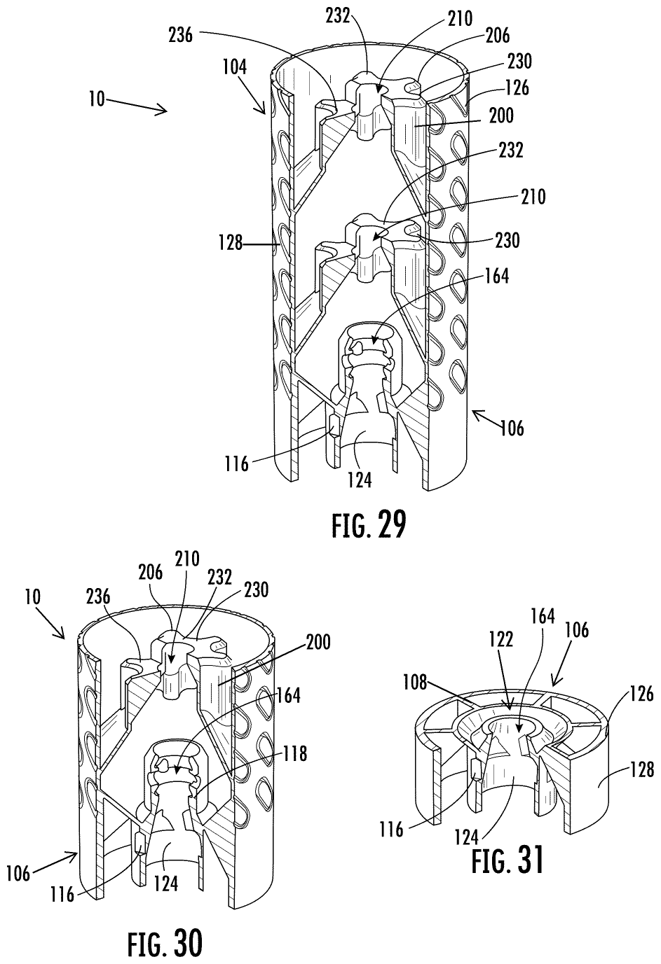

The entire shape of the suppressor 10, including the curved-sided hexagram baffles 200 is only achievable because of the development of additive manufacturing. Using the proper angling and radiuses for the baffles 200 so that the baffles 200 and the firearm suppressor did not collapse like a house of cards, the entire firearm suppressor 10 is manufactured using an additive manufacturing process by stacking each element on top of the other at an angle. Additionally, the use of additive manufacturing allows a manufacturer to make the firearm suppressor in a serial, mass production way, making it cost effective. Various variables went in to finding the perfect shape for the baffle. If the curves were too deep or the protrusions were too skinny, the firearm suppressor would fail or even collapse while manufacturing the suppressor. Because of additive manufacturing the curved-sided hexagram baffle 200 has an optimized radius that allows the transition from vertical walls to large over hangs required to be able to produce the shape while also not collapsing during the additive manufacturing process. In manufacturing the firearm suppressor 10, the suppressor may have anywhere from 5-10 baffles 200. Additionally, the additive manufacturing process makes the firearm suppressor 10 less noisy because of the way the firearm suppressor 10 is manufactured, it creates a wall because it has to be manufactured at an angle, so the angle inside reflects all the sound back into the sound test meter. Thus, by putting up a wall in front of the end of the firearm suppressor, the sound is reflected backward and therefore reduced. FIGS. 27-30 illustrate various embodiments of the firearm suppressor 10 of FIGS. 1-26, having varying lengths and number of baffles.

FIG. 31 illustrates an alternate embodiment of a second end of the firearm suppressor 10 of FIG. 1. While the second end 106 includes one or more struts 108 similar to the previously described embodiment, this end has an additional concave surface 122.

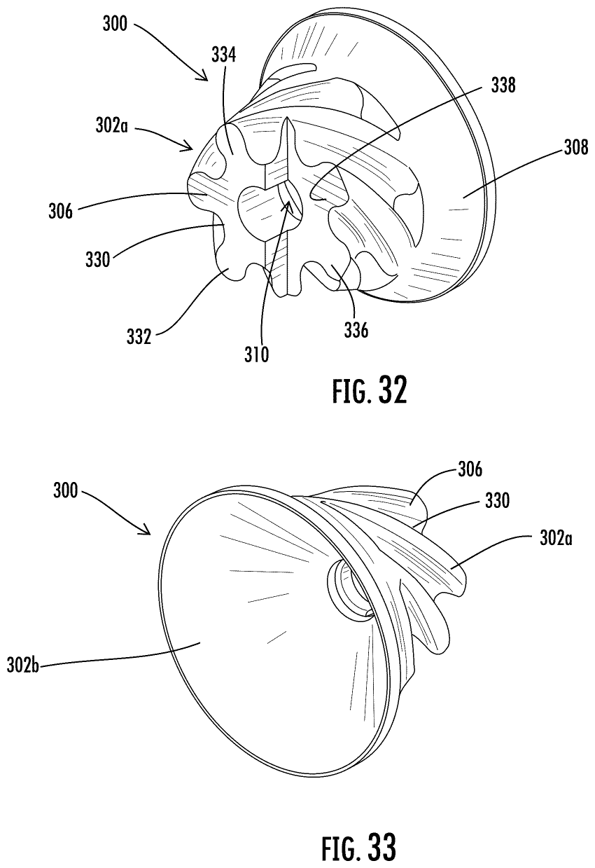

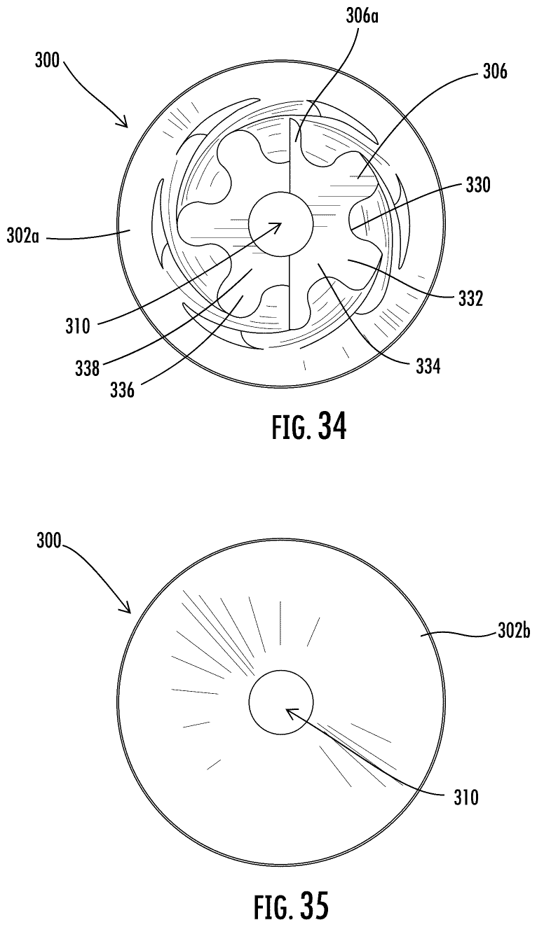

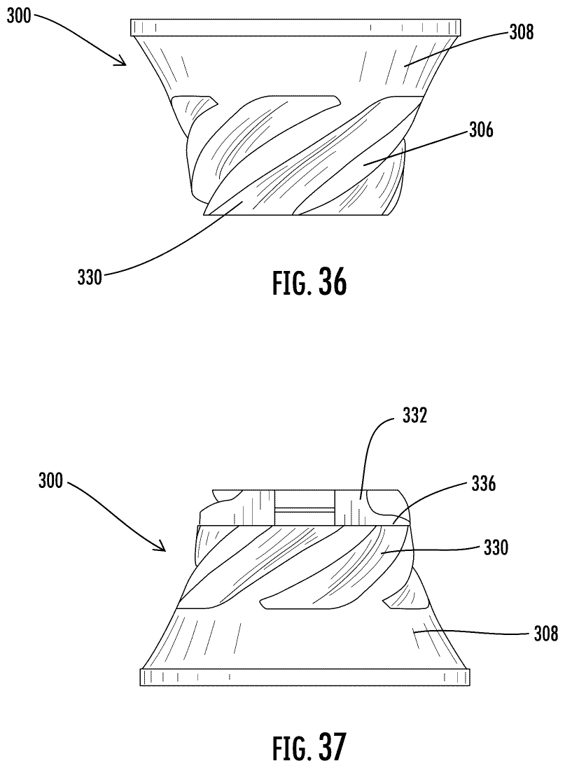

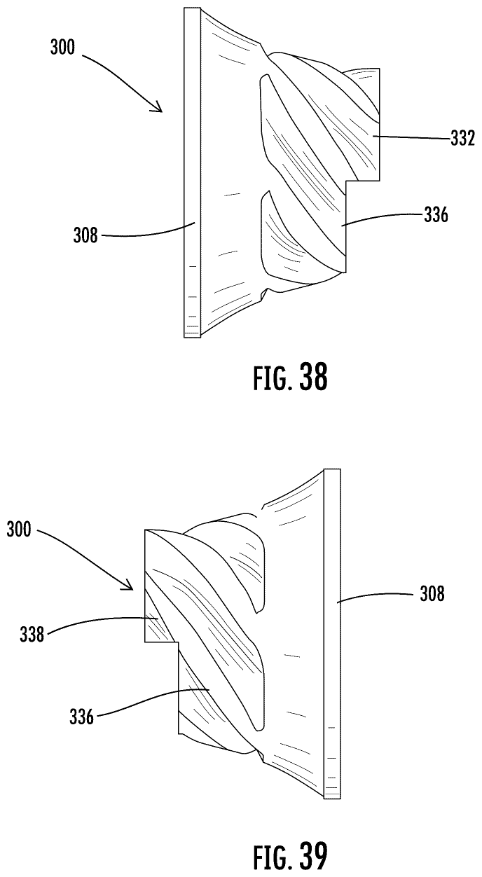

Referring to FIGS. 32-39, a second embodiment 20 of a 3D printed baffle 300 is illustrated. For purposes of clarity and ease of understanding, only the differences between this embodiment and the embodiment illustrated in FIGS. 1-31 will be discussed.

The second embodiment 20 includes one or more baffles 300 similar to the baffles 200 discussed above, but rather than six (6) arms, the present embodiment includes five, fully rounded arms 302, and two half-arms 304.

The alternate embodiment baffle 300 includes many of the same features as baffle 200, including a top surface 302a that faces the firearm and the first end 104. The top surface 302a includes arms 306, 306a fixedly coupled to a skirt 308, which is generally conical and has a convex surface that faces the first end 104 of the firearm suppressor 10. Unlike baffles 200, the arms 306 and valleys 330 of baffles 300 twist clockwise around the skirt 308. Additionally, the bottom surface 302b of the baffle 300 includes only a cone having a concave surface that faces the second end 106 of the firearm suppressor 10, with a center bore 310 extending between the top surface 302a and the bottom surface 302b.

Nevertheless, as seen with the curved-sided hexagram baffle 200, the twisted arms 306, 306a of baffle 300 include a two-step, upper portion 332 and lower portion 336 that faces the first end 104, the upper portion 332 being one step higher or longer than the lower portion 336.

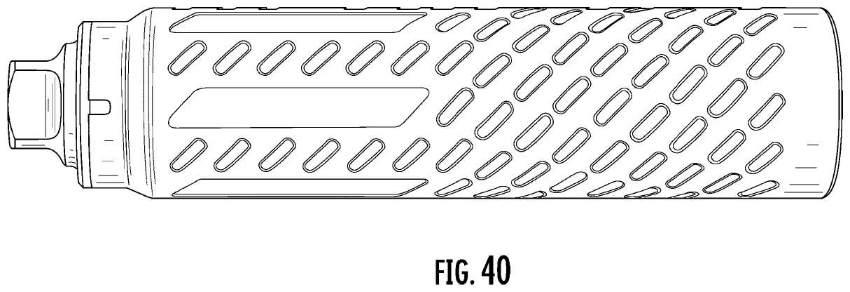

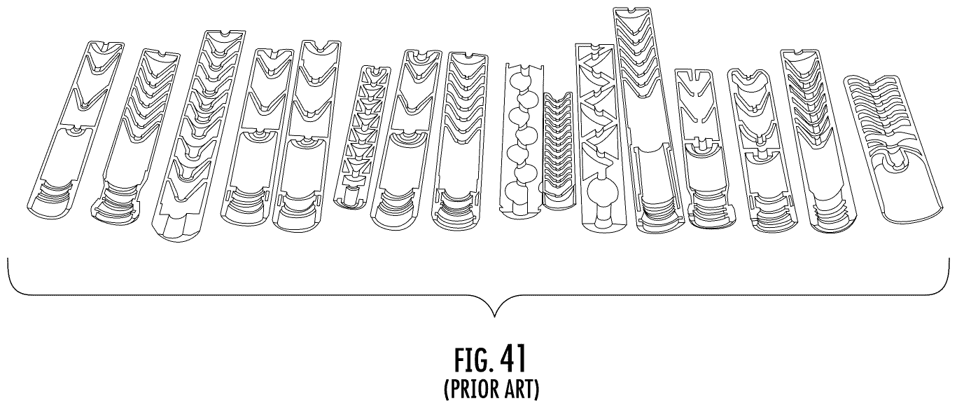

FIG. 40 is an exemplary design of the firearm suppressor of FIGS. 1-31 with an etched design that differentiates this firearm suppressor from other suppressors currently on the market.

FIG. 41 illustrates sectional views of baffles used in firearm suppressor in the prior art. As shown in FIG. 41, the curved-sided hexagram baffle has never been developed by another manufacturer.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

We claim:

1. A firearm suppressor, comprising:
an outer housing having first and second opposing ends;
a first baffle disposed in and connected to an inner surface of a wall of the outer housing proximate the first end, the first baffle including a first bore extending therethrough; and
at least one baffle disposed in and connected to the inner surface of the wall of the outer housing between the first and second opposing ends, wherein the at least one baffle includes a skirt and a stepped protrusion extending axially from the skirt, the stepped protrusion having an outer wall surface defined by a plurality of rounded arms, an upper portion, and a lower portion, the upper portion extending axially from the skirt further than the lower portion.

2. The firearm suppressor of claim 1, wherein the upper portion includes a first end wall and the lower portion includes a second end wall.

3. The firearm suppressor of claim 2, wherein the stepped protrusion further includes a bore extending through a portion of the first end wall and a portion of the second end wall.

4. The firearm suppressor of claim 1, further including at least one strut disposed in the first end and connected to the inner surface of the wall of the outer housing and the first baffle.

5. The firearm suppressor of claim 1, wherein each of the first baffle and at least one baffle are integrally formed with the inner surface of the wall of the outer housing.

6. The firearm suppressor of claim 1, wherein the first baffle includes a scallop to direct and control a flow of gases flowing through the firearm suppressor.

7. The firearm suppressor of claim 1, further including a tube in and connected to the inner surface of the wall of the outer housing proximate the second end, the tube including a bore extending therethrough.

8. The firearm suppressor of claim 7, wherein the tube includes at least one annular groove formed in an inner wall surface of the tube.

9. A firearm suppressor, comprising:
an outer housing having first and second opposing ends;
a first baffle disposed in and connected to an inner surface of a wall of the outer housing proximate the first end, the first baffle including a first bore extending therethrough;
a tube disposed in and connected to the inner surface of the wall of the outer housing proximate the second end, the tube including a second bore extending therethrough and a plurality of annular grooves formed in an inner wall surface of the tube; and
a plurality of intermediate baffles disposed in and connected to the inner surface of the wall of the outer housing between the first baffle and the tube, wherein each of the plurality of baffles include a third bore extending therethrough and a plurality of rounded arms surrounding the third bore.

10. The firearm suppressor of claim 9, wherein each of the first baffle, tube, and plurality of intermediate baffles are integrally formed with the inner surface of the outer wall of the outer housing.

11. The firearm suppressor of claim 9, wherein the plurality of intermediate baffles are hexagram baffles disposed in series in the outer housing.

12. The firearm suppressor of claim 9, wherein each of the plurality of intermediate baffles include:
a top surface facing the first end, wherein the plurality of rounded arms project outwardly from the top surface towards the first end; and
a bottom surface facing the second end, wherein the bottom surface includes a plurality of rounded valleys.

13. The firearm suppressor of claim 9, further including at least one strut disposed in the first end and connected to the inner surface of the wall of the outer housing and the first baffle.

14. The firearm suppressor of claim 9, wherein the first baffle includes a scallop to direct and control a flow of gases flowing through the firearm suppressor.

15. The firearm suppressor of claim 9, further including a plurality of flash vents disposed around the second bore of the tube.

16. The firearm suppressor of claim 9, wherein each of the plurality of baffles include a skirt and a protrusion extending axially from the skirt.

17. The firearm suppressor of claim 16, wherein the protrusion includes an upper portion and a lower portion, the upper portion extending axially from the skirt further than the lower portion.

18. The firearm suppressor of claim 9, wherein each of the plurality of intermediate baffles include:
a skirt having a wall with a top surface and a bottom surface; and
a protrusion extending axially from an end of the skirt and including an outer wall surface and an inner wall surface, the outer wall surface being defined by the plurality of rounded arms surrounding the third bore, wherein each of the plurality of arms is separated by a valley; and
wherein the protrusion further includes an upper portion with an end wall and a lower portion with an end wall, the upper portion extending axially further from the skirt than the lower portion, and wherein the third bore is defined by the end walls of the upper and lower portions.

19. A method of manufacturing the firearm suppressor of claim 1, comprising:
using an additive manufacturing process to build the firearm suppressor in a layer-by-layer fashion.
